(19) United States
(12) Patent Application Publication
(10) Pub. No.: US 2026/0319397 A1
(43) Pub. Date: Oct. 15, 2026

(54) IMAGE FORMING APPARATUS

(71) Applicant: Masayuki Kasukawa, Misato Saitama (JP)

(72) Inventor: Masayuki Kasukawa, Misato Saitama (JP)

(73) Assignee: ETRIA Co., Ltd., Kanagawa (JP)

(21) Appl. No.: 19/443,367

(22) Filed: Jan. 8, 2026

(30) Foreign Application Priority Data
Apr. 10, 2025 (JP) 2025-064963

(51) Int. Cl. G03G 15/08; G03G 21/16

(52) U.S. Cl. CPC G03G 15/0812; G03G 21/1676; G03G 2221/163

(57) ABSTRACT

An image forming apparatus according to an embodiment includes a developing roller, an image forming unit, a case, a doctor blade, and an adjustment screw. The case rotatably houses the developing roller. The doctor blade includes an opposing edge that faces the outer circumferential surface of the developing roller, and both longitudinal ends are fixed to the case. The adjustment screw extends between the ends of the doctor blade along a first direction in which the developing roller and doctor blade are aligned, and is threadably engaged with a nut fixed to the case. The adjustment screw includes a first pressing portion that presses the first pressed surface of the doctor blade in the first direction when rotated forward, and a second pressing portion that presses the second pressed surface of the doctor blade in a second direction opposite to the first direction when rotated backward.

### CROSS-REFERENCE TO RELATED APPLICATIONS

This application is based upon and claims the benefit of priority from Japanese Patent Application No.2025-064963, filed Apr. 10, 2025, the entire contents of which are incorporated herein by reference.

### FIELD

Embodiments described herein relate generally to image forming apparatuses such as MFPs (Multifunction Peripherals).

### BACKGROUND

The image forming apparatus includes a doctor blade that limits the amount of developer conveyed to a photosensitive drum by a developing roller to a predetermined amount. The doctor blade forms a constant gap with the outer surface of the developing roller, thereby controlling the amount of developer passing through the gap to a constant amount.

The doctor blade is attached to the case of the developing roller, for example, via a gap-adjusting spacer, with both longitudinal ends pressed against the bearings of the developing roller.

The doctor blade has approximately the same length as the developing roller. For this reason, even if both longitudinal ends are fixed to the developing roller with a constant gap, a blade of low straightness may curve slightly near the center, resulting in an uneven gap between the developing roller and the doctor blade. This curvature of the doctor blade can be convex or concave relative to the developing roller, and a uniform gap is difficult to maintain.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a schematic diagram showing an image forming apparatus according to an embodiment.

FIG. 2 is a schematic diagram showing a black image forming unit depicted in FIG. 1.

FIG. 3 is a partially enlarged perspective view illustrating a fixing structure of the doctor blade depicted in FIG. 2.

FIG. 4 is a schematic perspective view showing a configuration for adjusting the gap of the doctor blade depicted in FIG. 3.

FIG. 5 is a front view (a), a bottom view (b), and a top view (c) each showing the adjustment screw depicted in FIG. 4.

FIG. 6 is a partially enlarged cross-sectional view illustrating the gap adjustment method using the adjustment screw depicted in FIG. 5.

FIG. 7 is a partially enlarged cross-sectional view illustrating the gap adjustment method using the adjustment screw depicted in FIG. 5.

### DETAILED DESCRIPTION

An image forming apparatus according to an embodiment includes a developing roller, an image forming unit, a case, a doctor blade, and an adjustment screw. The developing roller includes an outer circumferential surface that conveys developer. The image forming unit forms an image using the developer conveyed by the developing roller. The case rotatably houses the developing roller. The doctor blade includes an opposing edge that faces the outer circumferential surface of the developing roller, with a fixed gap between them, and both longitudinal ends are fixed to the case. The adjustment screw extends between the ends of the doctor blade along a first direction in which the developing roller and doctor blade are aligned, and is threadably engaged with a nut fixed to the case. The adjustment screw includes a first pressing portion that presses the first pressed surface of the doctor blade in the first direction when rotated forward, and a second pressing portion that presses the second pressed surface of the doctor blade in a second direction opposite to the first direction when rotated backward.

The embodiment will now be described with reference to the drawings.

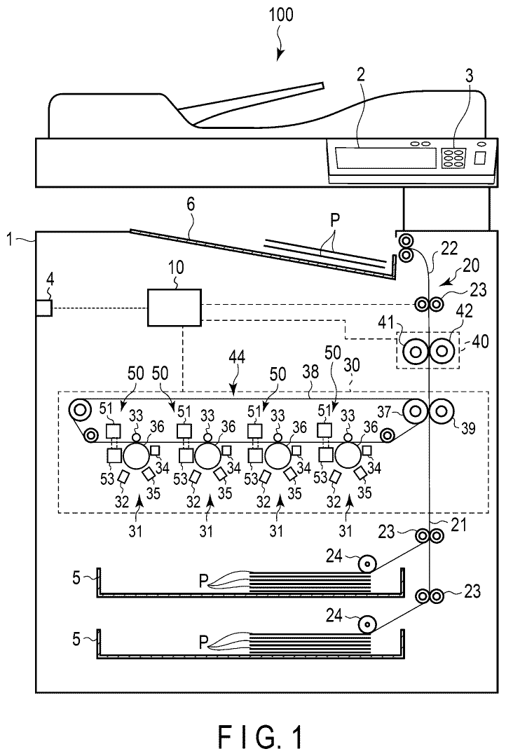

As shown in FIG. 1, an image forming apparatus 100 according to one embodiment includes a housing 1 that forms an outer shell of the apparatus. The image forming apparatus 100 includes a display unit 2 and an input unit 3 located at the top of the front side of the housing 1. Inside the housing 1 are a communication interface 4, a controller 10, paper cassettes 5, a transport unit 20, an image forming unit 30, and a fixing unit 40. The image forming apparatus 100 also includes a paper output tray 6 that receives paper P discharged from the apparatus after image formation.

The display unit 2 displays images in response to video signals input, for example, from a display control unit (not shown). The display unit 2 displays, for example, various operation guides for the image forming apparatus 100, various setting screens for the image forming apparatus 100, and status information such as the remaining amount of toner.

The input unit 3 includes a power key, a paper feed key, various function keys, a numeric keypad, a keyboard, etc. The input unit 3 supplies operation signals input by the operator to the controller 10. The input unit 3 may be configured as a touch panel integrated with the display unit 2.

The communication interface 4 is, for example, an interface for communicating with a higher-level device (external device). The communication interface 4 is, for example, a LAN connector. The communication interface 4 may also communicate wirelessly with other devices.

The controller 10 controls the operation of the image forming apparatus 100. By executing programs stored in memory, the controller 10 controls operations, including causing the transport unit 20 to convey paper P, the image forming unit 30 to form an image on the paper P, and the fixing unit 40 to fix the image on the paper P, and other operations.

The controller 10 performs various information processes by executing programs stored in memory. The controller 10 generates a print job, for example, based on image data obtained from an external device via the communication interface 4. The controller 10 stores the generated print job in memory. A print job includes image data to be formed on paper P. The image data may be data for forming an image on a single sheet of paper P, or data for forming an image on a plurality of sheets of paper P. The print job includes information indicating whether color printing or monochrome printing is to be performed.

The image forming apparatus 100 is equipped with a plurality of paper cassettes 5 (two cassettes in the present embodiment). Each paper cassette 5 is capable of accommodating a plurality of sheets of paper P of a predetermined size in a stacked manner, and is attachable to and detachable from the housing 1 from the front side.

The transport unit 20 conveys paper P within the image forming apparatus 100. The transport unit 20 is equipped with, for example, a paper feed transport path 21 and a paper discharge transport path 22. The transport unit 20 includes a plurality of pairs of transport rollers 23, each of which rotates while holding paper P therebetween to apply a conveying force. The transport unit 20 also includes a plurality of transport guides (not shown).

The paper feed transport path 21 conveys paper P picked up from the paper cassette 5 by the pickup roller 24 to the image forming unit 30. The paper discharge transport path 22 conveys paper P that has passed through the image forming unit 30 via the fixing unit 40. A discharge tray 6 is provided at the end of the paper discharge transport path 22.

The image forming unit 30 forms an image on paper P conveyed via the paper feed transport path 21, based on a print job generated by the controller 10. The image forming device 30 is equipped with a plurality of process units 31 (four process units in the present embodiment). Each of the plurality of process units 31 forms a developer image in cyan, magenta, yellow, or black. The image forming unit 30 includes an endless transfer belt 38 that transfers and conveys the four color developer images in a superimposed manner. Since the four process units 31 have substantially the same structure, a representative description will be given of the process unit 31 that forms a black developer image, which is the rightmost one in FIG. 1.

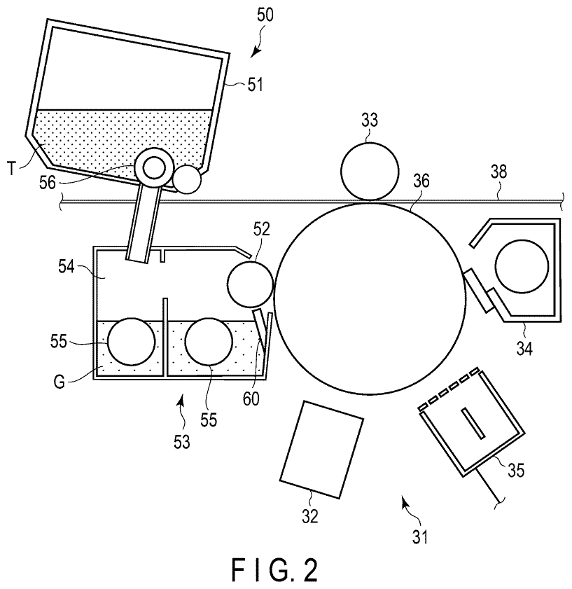

As shown in FIG. 2, the black process unit 31 includes an exposure device 32, a developing device 50, a primary transfer roller 33, a cleaner 34, a charging unit 35 and a photosensitive drum 36.

The exposure device 32 exposes the surface of the photosensitive drum 36, which has been charged to a predetermined potential by the charging unit 35, to light to form an electrostatic latent image of a black image.

The developing device 50 includes both a toner cartridge 51 which contains black toner T, and a developing unit 53. The developing unit 53 includes a case 54 that rotatably houses a developing roller 52 and contains two-component developer G. Inside the case 54, two stirring screws 55 are provided, extending parallel to the central axis of the photosensitive drum 36 (hereinafter referred to as the axial direction). The case 54 secures both axial ends of a doctor blade 60 facing the developing roller 52.

The developing device 50 rotates an auger 56 of the toner cartridge 51 to feed black toner T into the case 54 of the developing unit 53. The two stirring screws 55 inside the case 54 stir the carrier contained in the case 54 and the black toner T fed from the toner cartridge 51. The developing roller 52 includes a developing sleeve that magnetically attracts the two-component developer G containing black toner T charged by stirring, and generates a magnetic field to form a magnetic brush of black toner T on the outer surface of the developing sleeve. The doctor blade 60 regulates the thickness of the magnetic brush formed on the outer surface of the developing sleeve to a constant thickness.

The developing device 50 conveys a controlled amount of black toner T, regulated by the doctor blade 60, onto the surface of the photosensitive drum 36 by rotation of a developing roller 52, thereby developing the electrostatic latent image formed on the surface of the photosensitive drum 36.

The primary transfer roller 33 forms a predetermined electric field between itself and the photosensitive drum 36, and transfers the developer image of black toner T formed on the surface of the photosensitive drum 36 onto the surface of the transfer belt 38. The primary transfer roller 33 of each color process unit 31 transfers the developer image of each color onto the transfer belt 38 in synchronization with the movement of the transfer belt 38, so that the images are superimposed on one another.

The cleaner 34 presses a cleaning blade against the surface of the photosensitive drum 36 to remove residual toner of each color from the surface of the photosensitive drum 36.

The charging unit 35 uniformly charges the surface of the photosensitive drum 36 to a predetermined potential.

The photosensitive drum 36 includes a cylindrical drum and a photosensitive layer provided on the outer surface of the drum.

The image forming unit 30 includes a drive roller 37 around which the transfer belt 38 is wound, and a secondary transfer roller 39 facing the drive roller 37, with the transfer belt 38 sandwiched therebetween. The drive roller 37 is driven by a motor (not shown) to rotate the transfer belt 38 counterclockwise in FIG. 1 at a predetermined speed. The transfer belt 38 conveys a four-color developer image, which has been superimposed and transferred by the respective color process units 31, to a position between the drive roller 37 and the secondary transfer roller 39.

The transport unit 20 conveys paper P, which is taken out from the paper cassette 5, through the paper feed transport path 21 and feeds it between the secondary transfer roller 39 and the drive roller 37. The secondary transfer roller 39 forms a predetermined electric field between itself and the drive roller 37, and transfers the four-color developer image conveyed by the transfer belt 38 onto the paper P.

The fixing unit 40 includes a heat roller 41 and a press roller 42. The heat roller 41 and the press roller 42 are positioned opposite to each other, with the paper discharge transport path 22 located therebetween. The heat roller 41 heats the paper P to which the developer image of each color has been transferred, and melts the developer. The press roller 42 presses the melted developer of each color against the paper P to fix it. After image formation, the paper discharge transport path 22 conveys the paper P that has passed through the fixing unit 40 to the paper discharge tray 6.

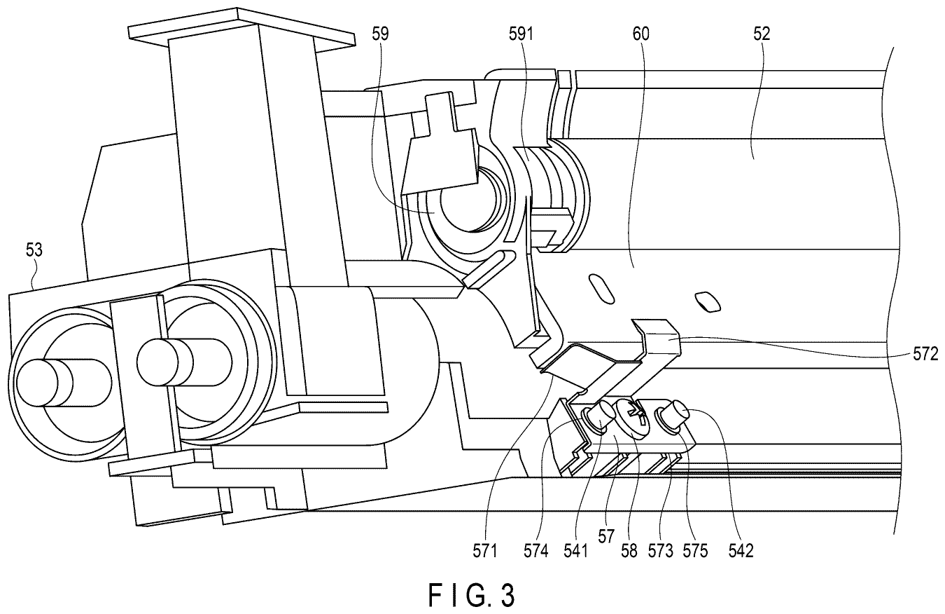

As shown in FIG. 3, the doctor blade 60 of the developing device 50 is mounted between the case 54 of the developing unit 53 and the developing roller 52. Since the developing devices 50 of the respective color process units 31 have the same structure and the fixing structures at both ends of the doctor blade 60 of each developing device 50 are substantially the same, the fixing structure on the front side of the doctor blade 60 of the developing device 50 for the black process unit 31 will be described below as a representative example.

The developing device 50 includes two mounting brackets 57 (only one at the front side is shown in FIG. 3) for attaching both longitudinal ends of the doctor blade 60 to the case 54. Each mounting bracket 57 integrally includes a first leaf spring portion 571, a second leaf spring portion 572, and a fixed portion 573. The first leaf spring portion 571 presses the front end of the doctor blade 60 against the developing roller 52. The second leaf spring portion 572 presses the front end of the doctor blade 60 against the case 54. The fixed portion 573 is continuous with the proximal ends of the first and second leaf spring portions 571 and 572, and is fixed to the case 54. For example, the mounting bracket 57 is formed by shaping and bending a single sheet of metal.

The fixed portion 573 includes two mounting holes 574 and 575 configured to receive two bosses 541 and 542 protruding from the case 54. The fixed portion 573 also includes an insertion hole through which a fixing screw 58 for fastening the mounting bracket 57 to the case 54 is inserted. In the state shown in FIG. 3, in which the fixed portion 573 is secured to the case 54 by the fixing screw 58, the first leaf spring portion 571 of the mounting bracket 57 generates a restoring force in a first direction, pressing the doctor blade 60 against the developing roller 52. Meanwhile, the second leaf spring portion 572 of the mounting bracket 57 generates a restoring force in a third direction, which is substantially perpendicular to the first direction, pressing the doctor blade 60 against the case 54.

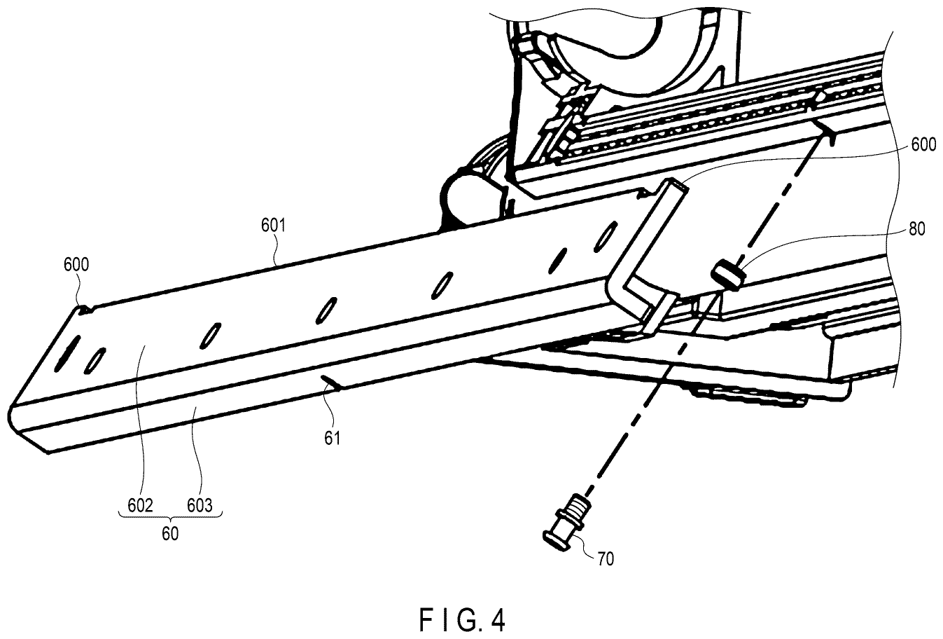

As shown in FIG. 4, the doctor blade 60 includes a generally rectangular, plate-shaped blade body 602 having a longitudinal opposing edge 601 facing the outer peripheral surface of the developing roller 52 across a predetermined gap, and a generally rectangular, plate-shaped reinforcing rib 603 integrally formed on the rear edge of the blade body 602 opposite to the opposing edge 601. The doctor blade 60 is an elongated member having an L-shaped cross section, formed by bending a single sheet metal along a line in the longitudinal direction at approximately a right angle. The width of the reinforcing rib 603 in the direction perpendicular to the longitudinal direction is shorter than that of the blade body 602.

The doctor blade 60 includes two pressing protrusions 600 at both longitudinal ends of the opposing edge 601. The tips of the pressing protrusions 600 extend beyond the opposing edge 601 in a direction away from the reinforcing rib 603. The length by which the pressing protrusions 600 protrude from the opposing edge 601 determines the gap between the doctor blade 60 and the developing roller 52. In other words, as shown in FIG. 3, the doctor blade 60 is fixed to the case 54 by the two mounting brackets 57, with its two pressing protrusions 600 at both longitudinal ends abutting the outer surfaces 591 of the bearings 59 provided at both ends of the developing roller 52. This makes it possible to maintain a constant gap between the opposing edge 601 of the doctor blade 60 and the outer surface of the developing roller 52.

Since the doctor blade 60 is made from a long metal plate that is roughly the same length as the developing roller 52, it is difficult to ensure high straightness and to make the opposing edge 601 straight. For this reason, if the doctor blade 60 is not straight enough in the present embodiment in which both longitudinal ends of the doctor blade 60 are fixed to the case 54, the gap between the opposing edge 601 and the outer surface of the developing roller 52 may become uneven near the center of the doctor blade 60. A doctor blade 60 with low straightness requires additional processing to straighten its opposing edge 601, or it must be discarded. In the present embodiment, therefore, an adjustment screw 70 is provided to adjust the gap between the opposing edge 601 and the outer surface of the developing roller 52 near the center of the long doctor blade 60.

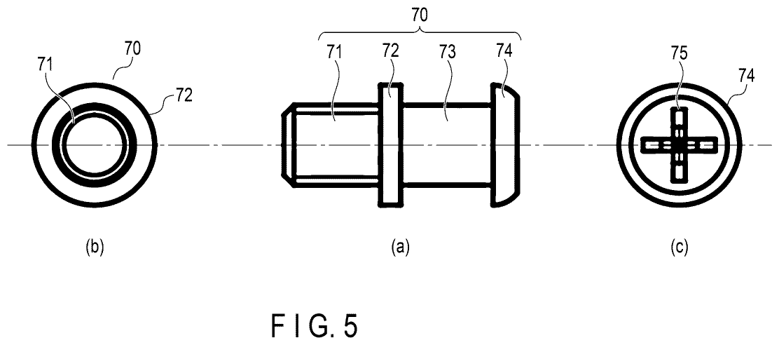

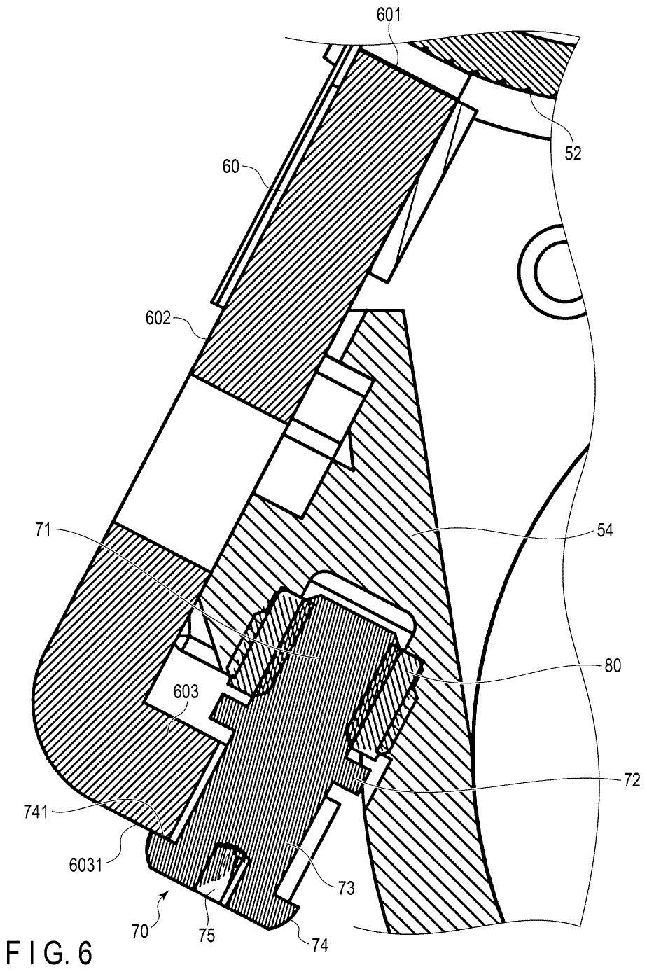

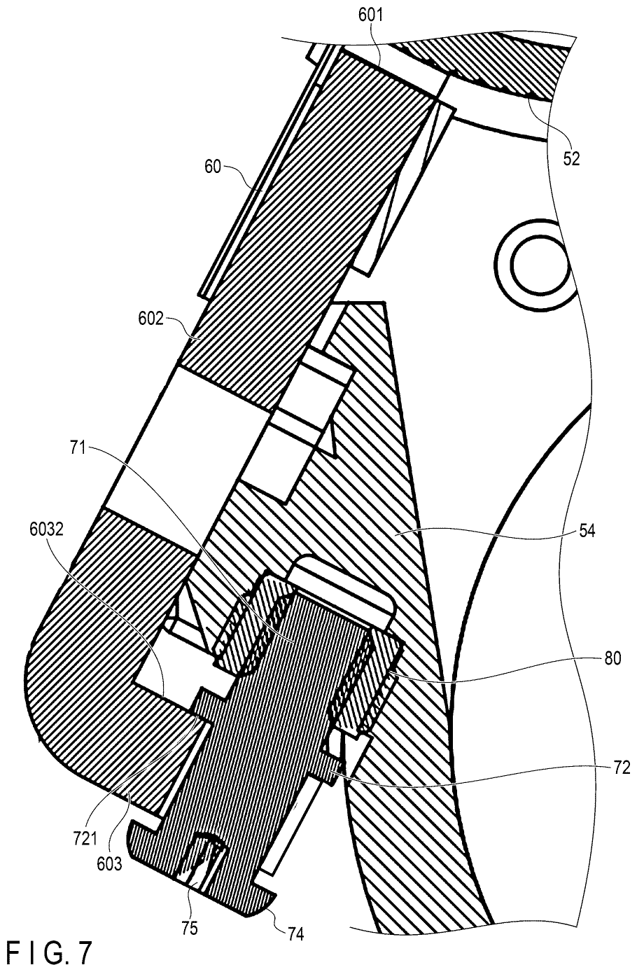

As shown in FIG. 5, the adjustment screw 70 is a specially shaped screw that is integrally and coaxially composed of: a threaded portion 71 that screws into a nut 80 (FIGS. 4, 6, and 7) embedded in the case 54; a circular plate-shaped flange portion 72 at the base end of the threaded portion 71; a cylindrical shank 73 extending from the side of the flange portion 72 opposite to the threaded portion 71; and a disk-shaped head portion 74 on the other side of the shank 73. The pitch of the threaded portion 71 of the adjustment screw 70 is approximately 0.2 mm to 0.5 mm. The head portion 74 of the adjustment screw 70 functions as a first pressing portion capable of pressing the outer surface 6031 (FIG. 6) of the doctor blade 60. The head portion 74 includes a cross-shaped groove 75 in which the tip of a driver (not shown) is fitted. The flange portion 72 functions as a second pressing portion capable of pressing the inner surface 6032 (FIG. 7) of the doctor blade 60.

The doctor blade 60 includes a U-shaped notch 61 (FIG. 4) at the longitudinal center, which is formed by cutting the edge of the reinforcing rib 603 on the side opposite the blade body 602. The notch 61 functions as a fitting portion in which the shank 73 of the adjustment screw 70 is fitted. The nut 80 is an insert nut embedded in the case 54. The nut 80 is embedded in the case 54 in an orientation such that the adjustment screw 70, with its threaded portion 71 screwed into the nut 80, extends in the first direction in which the doctor blade 60 and the developing roller 52 are aligned.

Referring mainly to FIGS. 6 and 7, a method of adjusting the doctor blade 60 will be described.

In the case where the center of the doctor blade 60, which is fixed to the case 54 at both ends, is curved concavely toward the outer peripheral surface of the developing roller 52, that is, in the case where the gap between the opposing edge 601 at the longitudinal center of the doctor blade 60 and the outer peripheral surface of the developing roller 52 exceeds the design value, the adjustment screw 70 is rotated in the tightening direction, as shown in FIG. 6. When the adjustment screw 70 is tightened, the annular flat surface 741 on the shank side of the head portion 74 presses the outer surface 6031 (first pressed surface) of the reinforcing rib 603 of the doctor blade 60 in the direction of the developing roller 52 (first direction), thereby moving the center of the doctor blade 60 closer to the developing roller 52 and reducing the central gap.

Conversely, in the case where the center of the doctor blade 60 fixed to the case 54 at both ends curves convexly toward the outer peripheral surface of the developing roller 52, that is, in the case where the gap between the opposing edge 601 at the longitudinal center of the doctor blade 60 and the outer peripheral surface of the developing roller 52 is smaller than the design value, the adjustment screw 70 is rotated in the reverse direction to loosen the screw, as shown in FIG. 7. When the adjustment screw 70 is loosened, the annular flat surface 721 of the flange portion 72 on the side of the shank 73 presses the inner surface 6032 (second pressed surface) of the reinforcing rib 603 of the doctor blade 60 in a direction away from the developing roller 52 (second direction), thereby deforming the center of the doctor blade 60 away from the developing roller 52 and increasing the central gap.

The adjustment range of the gap using the adjustment screw 70 is approximately ±0.05 mm. It is therefore preferable that the pitch of the threaded portion 71 of the adjustment screw 70 be approximately 0.2 mm to 0.5 mm. The threaded portion 71 may be, for example, either a fine-pitch thread or a coarse-pitch thread. Furthermore, the position for gap adjustment using the adjustment screw 70 does not need to be exactly at the longitudinal center of the doctor blade 60; it can be anywhere between the two ends of the blade, preferably near the center.

As described above, according to the present embodiment, by using a single special-shaped adjustment screw 70 having a flange portion 72, the gap between the opposing edge 601 of the doctor blade 60 at its longitudinal center and the outer peripheral surface of the developing roller 52 can be adjusted in both positive and negative directions. Thus, the gap of the doctor blade 60 relative to the developing roller 52 can be made uniform over the entire length of the developing roller 52. Accordingly, in the present embodiment, doctor blades 60 with low straightness, which would otherwise require reworking or be discarded, can still be used. This reduces the need for reworking and waste, thereby lowering manufacturing costs.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a developing roller including an outer peripheral surface that carries and conveys developer;
an image forming unit that forms an image using the developer conveyed by the developing roller;
a case that rotatably houses the developing roller;
a doctor blade including an opposing edge facing the outer peripheral surface of the developing roller, with a predetermined gap therebetween, and with both longitudinal ends fixed to the case; and
an adjustment screw extending between the ends of the doctor blade along a first direction in which the developing roller and the doctor blade are aligned, and being threadably engaged with a nut fixed to the case, the adjustment screw including a first pressing portion that presses a first pressed surface of the doctor blade in the first direction when rotated forward, and a second pressing portion that presses a second pressed surface of the doctor blade in a second direction opposite to the first direction when rotated backward.

2. The image forming apparatus according to claim 1, wherein the first pressing portion is a head of the adjustment screw, and the second pressing portion is an annular flange portion provided integrally with a shank of the adjustment screw and spaced apart from the head.

3. The image forming apparatus according to claim 1, wherein the adjustment screw is disposed at a longitudinal center of the doctor blade.

4. The image forming apparatus according to claim 1, wherein the doctor blade includes a substantially rectangular plate-shaped blade body including the opposing edge, and a substantially rectangular plate-shaped reinforcing rib integrally formed on a rear edge of the blade body opposite to the opposing edge and extending in a third direction intersecting the first direction, the reinforcing rib including the first pressed surface and the second pressed surface.

5. The image forming apparatus according to claim 4, wherein the adjustment screw is disposed at a longitudinal center of the doctor blade.

6. The image forming apparatus according to claim 2, wherein the doctor blade includes a substantially rectangular plate-shaped blade body including the opposing edge, and a substantially rectangular plate-shaped reinforcing rib integrally formed on a rear edge of the blade body opposite to the opposing edge and extending in a third direction intersecting the first direction, the reinforcing rib including the first pressed surface, the second pressed surface, and a fitting portion in which the shank of the adjustment screw is fitted.

7. The image forming apparatus according to claim 6, wherein the adjustment screw is disposed at a longitudinal center of the doctor blade.

8. The image forming apparatus according to claim 7, wherein the fitting portion is a U-shaped notch formed by cutting out an edge of the reinforcing rib opposite to the blade body.

9. The image forming apparatus according to claim 1, wherein the adjustment screw has a pitch of approximately 0.2 mm to 0.5 mm.

10. The image forming apparatus according to claim 9, wherein the nut is an insert nut embedded in the case.

11. A developing apparatus comprising:
a developing roller including an outer peripheral surface that carries and conveys developer;
a case that rotatably houses the developing roller;
a doctor blade including an opposing edge facing the outer peripheral surface of the developing roller with a predetermined gap therebetween, and with both longitudinal ends fixed to the case; and
an adjustment screw extending between the ends of the doctor blade along a first direction in which the developing roller and the doctor blade are aligned, and being threadably engaged with a nut fixed to the case, the adjustment screw including a first pressing portion that presses a first pressed surface of the doctor blade in the first direction when rotated forward, and a second pressing portion that presses a second pressed surface of the doctor blade in a second direction opposite to the first direction when rotated backward.

12. The developing apparatus according to claim 11, wherein the first pressing portion is a head of the adjustment screw, and the second pressing portion is an annular flange portion formed integrally with a shank of the adjustment screw and spaced apart from the head.

13. The developing apparatus according to claim 11, wherein the adjustment screw is disposed at a longitudinal center of the doctor blade.

14. The developing apparatus according to claim 11, wherein the doctor blade includes a substantially rectangular plate-shaped blade body including the opposing edge, and a substantially rectangular plate-shaped reinforcing rib integrally formed on a rear edge of the blade body opposite to the opposing edge and extending in a third direction intersecting the first direction, the reinforcing rib including the first pressed surface and the second pressed surface.

15. The developing apparatus according to claim 14, wherein the adjustment screw is disposed at a longitudinal center of the doctor blade.

16. The developing apparatus according to claim 12, wherein the doctor blade includes a substantially rectangular plate-shaped blade body including the opposing edge, and a substantially rectangular plate-shaped reinforcing rib integrally formed on a rear edge of the blade body opposite to the opposing edge and extending in a third direction intersecting the first direction, the reinforcing rib including the first pressed surface, the second pressed surface, and a fitting portion in which the shank of the adjustment screw is fitted.

17. The developing apparatus according to claim 16, wherein the adjustment screw is disposed at a longitudinal center of the doctor blade.

18. The developing apparatus according to claim 17, wherein the fitting portion is a U-shaped notch formed by cutting out an edge of the reinforcing rib opposite to the blade body.

19. The developing apparatus according to claim 11, wherein the adjustment screw has a pitch of approximately 0.2 mm to 0.5 mm.

20. The developing apparatus according to claim 19, wherein the nut is an insert nut embedded in the case.
